(19) United States
(12) Patent Application Publication
(10) Pub. No.: US 2025/0268426 A1
(43) Pub. Date: Aug. 28, 2025

(54) A REMOVABLE HANDLE FOR POTS AND PANS

(71) Applicant: Inter IKEA Systems B.V., Delft (NL)

(72) Inventors: Edward Dahlin, Dio (SE); Anna Nihlen, Malmo (SE)

(21) Appl. No.: 18/878,003

(22) PCT Filed: Jun. 7, 2023
(86) PCT No.: PCT/SE2023/050570

§ 371 Date: Dec. 20, 2024

(30) Foreign Application Priority Data
Jun. 23, 2022 (SE) 2250781-8

(51) Int. Cl. A47J 45/07

(52) U.S. Cl. CPC A47J 45/071

(57) ABSTRACT

A removable handle for pots and pans may include a first elongated member, which may include a first engagement portion and a first grip portion, and a second elongated member, which may include a second engagement portion. The elongated members may be pivotably connected. The engagement portions may be configured for locking engagement with complementary shaped engagement portions of an attachment member of a pot and/or a pan. The first manual grip portion and a second manual grip portion may be connected to the first engagement portion and the second engagement portion such that a movement of the grip portions towards each other is transmitted to a movement of the engagement portions closer to each other. The first elongated member may further include a support portion for laterally supporting the removable handle relative to complementary shaped support surfaces of the attachment member of the pot and/or the pan.

### CROSS-REFERENCE TO RELATED APPLICATIONS

This application claims priority to International Patent Application No. PCT/SE2023/050570, filed on Jun. 7, 2023, and Swedish Patent Application No. SE 2250781-8, filed on Jun. 23, 2022, the contents of both of which are hereby incorporated by reference in their entirety.

### TECHNICAL FIELD

The invention relates to a removable handle for pots and pans, especially for food preparation. The invention further relates to such a pot or pan adapted for connection with a removable handle.

### BACKGROUND

Removable handles for pots and pans are known since a long time for outdoor use, such as in association with camping stoves, wherein they provide for a space-efficient packaging. Removable handles are also known for indoor applications, such as in households, to achieve space-efficient storage solutions in kitchen cabinets and drawers.

According to a first known removable handle of a basic type (for outdoor use), it is adapted to grip around an edge (or rim) of a container of the pot or pan. The removable handle comprises a first elongated member formed in a one-piece unit and a second elongated member also formed in a one-piece unit that are pivotably connected via a pivot axis. Each one of the elongated members comprises a generally straight manual grip portion at a rear side of the pivot axis and an engagement portion at a front side of the pivot axis. The engagement portion extends in a transverse direction relative to the respective straight manual grip portion. The removable handle is assembled to the container with the manual grip portions in a diverging configuration and the engagement portions consequently spaced so that the edge of the container may be received between the engagement portions. The manual grip portions may then be moved towards each other by means of a single hand grip, wherein the engagement portions will contact the container wall on either side and press against the container wall so that the removable handle is attached to the container as long as the manual grip portions are held together.

U.S. Pat. No. 7,478,735 discloses a removable handle of a more advanced type (for indoor use) that is adapted to grip around an edge (or rim) of a container of the pot or pan. The removable handle comprises a first elongated member that is generally straight and comprises a first manual grip portion at a rear part and a first engagement portion at a front end extending in a transverse direction relative to the longitudinal direction of the first elongated member. The removable handle further comprises a second manual grip portion that is pivotably attached to the first elongated member. The first elongated member further forms a body for supporting a second elongated member that is adapted to be extendable and retractable in the longitudinal direction of the first elongated member. The second elongated member comprises a second engagement portion at a front end extending in a transverse direction relative to the longitudinal direction of the second elongated member. The grip portions are connected to the engagement portions in a way that a movement of the grip portions towards each other is transmitted to a movement of the engagement portions towards each other wherein the engagement portions may contact the container wall on either side and press against the container wall so that the removable handle is attached to the container. The removable handle further comprises a detent mechanism for locking the elongated members when moved together to the closed state and a detent release mechanism in the form of a button arrangement.

U.S. Pat. No. 7,975,874 discloses a removable handle that is adapted to engage with a complementary shaped attachment member rigidly attached to an outside surface of a container of the pot or pan. The attachment member is formed by a plate-like bent part that comprises a medial portion spaced apart from a circumferential surface of the container. The removable handle comprises two flanges extending perpendicularly to a longitudinal direction of the removable handle and adapted to be received in the space between the medial portion and the circumferential surface of the container and supported. The medial portion of the attachment member further comprises a central flexible flange defined by two slots, wherein the flexible flange comprises a pin hole for receipt of a locking pin of the removable handle. The removable handle comprises a thumb slide adapted for moving the locking pin in a longitudinal direction of the removable handle for insertion in the pin hole of the attachment member.

### SUMMARY

A first object of the invention is to achieve a removable handle, that is easy to operate, provides for a secure attachment to the pot or pan and provides for an aesthetically preferred design in an assembled state with regard to the pot or pan.

The object is achieved by a removable handle according to claim 1. Thus, it is achieved by a removable handle for pots and pans, wherein the removable handle comprises a first engagement portion and a second engagement portion adjacent a front end of the removable handle and adapted for locking engagement with complementary shaped engagement portions of an attachment member of the pot or pan, wherein the removable handle comprises a first manual grip portion and a second manual grip portion arranged in a rear part of the removable handle, wherein the grip portions are connected to the engagement portions in a way that a movement of the grip portions towards each other is transmitted to a movement of the engagement portions closer to each other, wherein the removable handle comprises a first elongated member that comprises the first engagement portion and the first grip portion and a second elongated member that comprises the second engagement portion, wherein the elongated members are pivotably connected via a pivot axis, wherein the first engagement portion has a main operative extension substantially in parallel with a longitudinal direction of the first elongated member and wherein the second engagement portion has a main operative extension in a transverse direction relative to a longitudinal direction of the second elongated member, wherein the first elongated member comprises a support portion adjacent the front end for laterally supporting the removable handle relative to complementary shaped support surfaces of the attachment member of the pot or pan, wherein the support portion has a main operative extension in a transverse direction to a longitudinal direction of the first elongated member.

The wording “man operative extension” refers to an operation direction of movement during assembly of the removable handle.

According to one example, the removable handle is operable by using a single hand, wherein a user may grip the grip portions between a palm of the hand and the four fingers (except for the thumb).

According to one example, the removable handle may comprise an end stop for providing a limit to an angular relative displacement of the manual grip portions so that a user may grip the grip portions between a palm of the hand and the four fingers (except for the thumb) in any relative angular configuration.

According to one example, the first manual grip portion and the first engagement portion are integrally formed with the first elongated member so that they are in a rigid configuration relative to one another. Further, the second manual grip portion and the second engagement portion are integrally formed with the second elongated member so that they are in a rigid configuration relative to one another. Thus, according to this example, both the manual grip portions are pivotably arranged relative to one another via the pivot axis and the engagement portions are pivotably arranged relative to one another via the pivot axis. Consequently, a movement of the grip portions from an open state, in which the grip portions are in a diverging configuration, towards each other, ie towards a closed state, in which the grip portions may be in parallel with each other, is directly transmitted to a movement of the engagement portions closer to each other for a locking engagement with complementary shaped engagement portions of the attachment member of the pot or pan.

The removable handle provides for a secure and intuitive operation in that a user may visually follow parts of a travel path of the second engagement portion while the grip portions are moved towards each other.

According to one example, the support portion has a main operative extension in a perpendicular direction to a longitudinal direction of the first elongated member. More specifically, the support portion extends in a plane perpendicular to the pivot axis. The support portion provides for a secure connection and a tight fit between the removable handle and the attachment member of the pot or pan.

According to an alternative, the removable handle may comprise a transmission between the manual grip portions and the engagement portions for achieving that a movement of the grip portions towards each other is transmitted to a movement of the engagement portions closer to each other.

According to one embodiment example, the second engagement portion comprises a guide surface adapted for a guiding engagement with a guide surface of one of the complementary shaped engagement portions of the attachment member of the pot or pan so that the removable handle may be moved in a longitudinal direction of the first elongated member and thereby causing a movement of the first engagement portion in engagement with another one of the complementary shaped engagement portions of the engagement member of the pot or pan when the grip portions are moved towards each other.

According to one example, the second engagement portion has a main operative extension in a perpendicular direction relative to the longitudinal direction of the second elongated member. More specifically, the second engagement portion forms a projection at a front end of the second elongated member. More specifically, the projection extends in a plane perpendicular to the pivot axis. According to one example, the guide surface of the second engagement portion is provided on a side of the second engagement portion that faces away from the front end.

According to a further embodiment example, the first engagement portion forms a projection for being received in a complementary shaped hole in the attachment member of the pot or pan. According to one preferred example, the projection comprises a tapering free end for facilitating entry in the associated hole.

According to a further embodiment example, the first engagement portion projects from the support portion. It creates conditions for a two step assembly, wherein the removable handle in a first step is arranged in an open state and moved so that the support portion is positioned in its associated receptacle in the attachment member of the pot or pan while being guidingly supported laterally by the complementary shaped support surfaces of the attachment member to a final position vertically, wherein the first projecting engagement portion is horizontally in line with its associated hole. Further, in a second step, the removable handle may be moved to a closed state by bringing the manual grip portions together, wherein the guide surface of the second engagement portion is guided by the guide surface of the complementary shaped engagement portion of the attachment member so that the removable handle is moved in its longitudinal direction towards the pot or pan and consequently, the first projecting engagement portion enters its associated hole.

According to a further embodiment example, the first elongated member comprises a body portion, wherein the support portion is spaced from the body portion in the longitudinal direction of the first elongated member and wherein the second engagement portion of the second elongated member is adapted to be received in the space between the body portion and the support portion.

According to one example, the first engagement portion projects from the body portion in the space between the body portion and the support portion.

According to a further embodiment example, the removable handle comprises a detent mechanism for locking the elongated members when moved together in a closed state.

According to a further embodiment example, the first elongated member comprises the detent mechanism, wherein the detent mechanism comprises two hook parts that are adapted to be resiliently separated from each other for holding the second elongated member when the elongated members are moved to the closed state.

According to a further embodiment example, the removable handle comprises a detent release arrangement, wherein the elongated members are pivotably connected around the pivot axis so as to allow them to be moved from the closed state to an open state when the detent release arrangement is operated.

According to a further aspect of the invention, it regards a pot or pan specifically adapted for allowing a removable connection with a removable handle.

According to one embodiment example, it regards a pot or pan comprising an attachment member rigidly attached to an outside surface of a container of the pot or pan for allowing attachment of a removable handle, wherein the attachment member comprises a first engagement portion with a main operative extension in parallel with a plane defined by the bottom of the container for engagement with a complementary shaped first engagement portion of the removable handle, wherein the attachment member comprises a second engagement portion in the form of a receptacle that is open in a direction perpendicular to the bottom of the container for receipt of a complementary shaped second engagement portion of the removable handle, wherein the second engagement portion of the attachment member comprises two lateral support surfaces defining the receptacle for laterally supporting a support portion of the removable handle. According to one example, the receptacle is open in an upwards direction.

According to a further embodiment example, the second engagement portion comprises a guide surface adapted for a guiding engagement with a guide surface of the second engagement portion of the removable handle so that the removable handle may be moved towards the outside surface of the container of the pot or pan and thereby causing the first engagement portions in engagement with one another when grip portions of the removable handle are moved towards each other.

According to one example, the attachment member comprises a frame defining the receptacle, wherein two spaced walls of the frame define the receptacle in a radial direction of the container. An outer wall of the two radially spaced walls may comprise the guide surface at an inner side facing the receptacle. Further, one of said radially spaced walls, or both walls may be provided with a radially extending hole for receipt of an associated projecting first engagement portion of the removable handle.

According to one example, the frame of the attachment member defining the receptacle, comprises two spaced walls in a circumferential direction of the container. Each one of the circumferentially spaced walls may comprise a lateral support surface defining the receptacle for laterally supporting a support portion of the removable handle.

According to a further aspect of the invention, it regards a kit of parts comprising at least one pot or pan according to any one of the embodiment examples as indicated above and a removable handle according to any one of the embodiment examples as indicated above.

Further advantages and advantageous features of the invention are disclosed in the following description and in the dependent claims.

With reference to the appended drawings, below follows a more detailed description of embodiments of the invention cited as examples.

### BRIEF DESCRIPTION OF THE DRAWINGS

In the drawings:

FIG. 1 is a perspective view from below of a removable handle in a closed state according to a first embodiment,

FIG. 2 is a partly cut perspective view of the removable handle according to a FIG. 1 in an open state,

FIG. 3 is an exploded view of parts of the removable handle according to a FIG. 1,

FIG. 4a is a partly cut perspective view of the removable handle according to a FIG. 1 indicating a detent mechanism,

FIG. 4b is a cross section view in plane A-A of FIG. 4a, wherein the detent mechanism is indicated in a locked state,

FIG. 4c is a cross section view in plane A-A of FIG. 4a, wherein the detent mechanism is indicated in an unlocked state,

FIG. 5 is a partly cut perspective view of the removable handle in FIG. 1 and an associated pan according to a first embodiment in an initial assembly state,

FIG. 6 is a partly cut perspective view of the removable handle and associated pan according to FIG. 5 in an intermediate assembly state,

FIG. 7 is a partly cut perspective view of the removable handle and associated pan according to FIG. 6 in a consecutive assembly state,

FIG. 8 is a partly cut perspective view of the removable handle and associated pan according to FIG. 7 in a final assembled state, and

FIG. 9 indicates a kit of parts comprising a removable handle according to FIG. 1 and a plurality of associated pots and pans.

### DETAILED DESCRIPTION

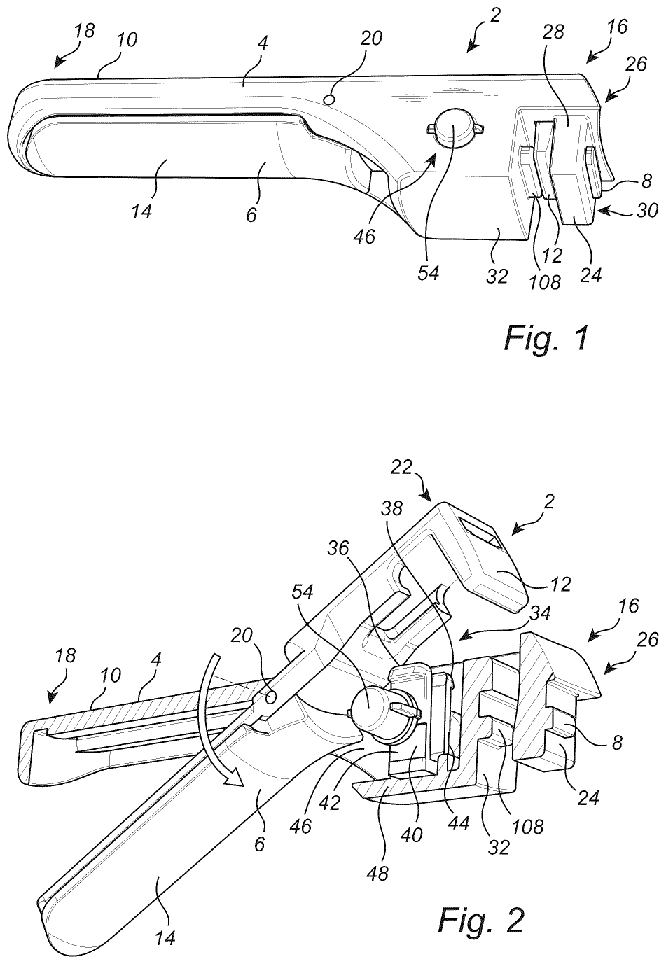

FIG. 1 is a perspective view from below of a removable handle 2 in a closed state according to a first embodiment. FIG. 2 is a partly cut perspective view of the removable handle 2 according to a FIG. 1 in an open state.

The removable handle 2 comprises a first elongated member 4 and a second elongated member 6. The first elongated member 4 comprises a first engagement portion 8, 108 and a first manual grip portion 10. The second elongated member 6 comprises a second engagement portion 12 and a second manual grip portion 14. The first engagement portion 8, 108 and the second engagement portion 12 are arranged adjacent a front end 16 of the removable handle 2. The first manual grip portion 10 and the second manual grip portion 14 are arranged in a rear part 18 of the removable handle. The first elongated member 4 and the second elongated member 6 are pivotably connected via a pivot axis 20. The removable handle 2 is designed so that the manual grip portions 10, 14 are arranged on a rear side of the pivot axis and the engagement portions 8, 108, 12 are arranged on a front side of the pivot axis.

The grip portions 10, 14 are connected to the engagement portions 8, 108, 12 in a way that a movement of the grip portions towards each other is transmitted to a movement of the engagement portions 8, 108, 12 closer to each other.

The first grip portion 10 comprises a first hand contact surface facing in an upwards direction, wherein the second grip portion 14 comprises a second hand contact surface facing in a downwards direction, wherein the first hand contact surface and the second hand contact surface may be pushed towards each other via a user hand movement.

The elongated members 4, 6 are pivotably connected around the pivot axis 20 so as to allow them to be moved from an open state, see FIG. 2, in which the elongated members are in a first angular relationship, to a closed state, see FIG. 1, in which the elongated members 4, 6 are in a second angular relationship, when the grip portions 10, 14 are moved towards each other.

More specifically, the elongated members 4, 6 are arranged in a crosswise relationship in the open state and in parallel with each other in the closed state. The first elongated member 4 has a generally straight extension. Likewise, the second elongated member 6 has a generally straight extension.

The first engagement portion 8, 108 has a main operative extension substantially in parallel with a longitudinal direction of the first elongated member 4. More specifically, the first engagement portion 8, 108 forms a projection.

The first elongated member 4 comprises a support portion 24 adjacent a front end 26 of the first elongated member 4 for laterally supporting the removable handle 2 in an assembled state. More specifically, the support portion 24 has two spaced lateral support surfaces 28, 30 adapted for laterally supporting the removable handle 2 in the assembled state. The support portion 24 has a main operative extension in a transverse direction to a longitudinal direction of the first elongated member 4. More specifically, the support portion 24 has a main operative extension generally perpendicular relative to the longitudinal direction of the first elongated member 4. Further, the support portion 24 extends in a plane perpendicular to the pivot axis 20. Further, the support portion 24 projects from the front end 26 of the first elongated member 4. Further, a first one of the first engagement portion 8 projects from the support portion 24 in a forwards direction away from the pivot axis 20. The first one of the first engagement portion 8 has an elongate shape in a lateral direction of the first elongated support member 4.

The first elongated member 4 further comprises a body portion 32, that extends generally perpendicular relative to the longitudinal direction of the first elongated member 4. The support portion 24 is spaced from the body portion 32 in the longitudinal direction of the first elongated member 4 and wherein the second engagement portion 12 of the second elongated member 6 is adapted to be received in the space between the body portion 32 and the support portion 24. Further, a second one of the first engagement portion 108 projects from the body portion 32 in the space between the body portion 32 and the support portion 24.

The first one of the first engagement portion 8 and the second one of the first engagement portion 108 are in parallel with each other in a direction of the main operative extension and have substantially the same shape and dimension.

The second engagement portion 12 has a main operative extension in a transverse direction relative to a longitudinal direction of the second elongated member 6. More specifically, the second engagement portion 12 has a main operative extension generally perpendicular relative to a longitudinal direction of the second elongated member 6. Further, the second engagement portion 12 extends in a plane perpendicular to the pivot axis 20. Further, the second engagement portion 12 projects from a front end 22 of the second elongated member 6.

Further, the second elongated member 6 has substantially the same width in a lateral direction along the complete length of the second elongated member 6. The second engagement portion 12 has generally the same width in a lateral direction as the width of an adjacent part of the second elongated member 6.

The removable handle 2 further comprises a detent mechanism 34 for locking the elongated members 4, 6 when moved together to the closed state. The first elongated member 4 comprises the detent mechanism 34. Further, the detent mechanism 34 comprises two hook parts 36, 38 facing each other that are adapted to be resiliently separated from each other when the elongated members 4, 6 are moved to the closed state for holding the second elongated member 6. More specifically, the detent mechanism 34 comprises a U-shaped element 40 that comprises the two hook parts 36, 38 at the free ends of the legs 42, 44.

Further, the removable handle 2 comprises a detent release arrangement 46, wherein the elongated members 4, 6 are pivotably connected around the pivot axis 20 so as to allow them to be moved from the closed state to the open state when the detent release arrangement 46 is operated.

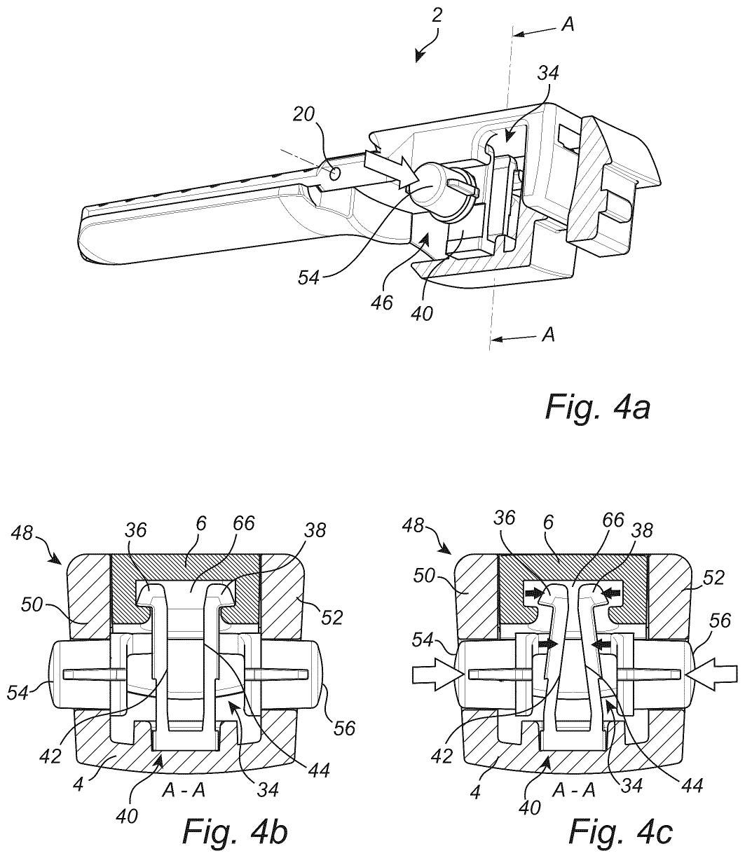

The first elongated member 4 comprises a housing 48, wherein the housing 48 comprises two lateral walls 50, 52, see also FIG. 4b and FIG. 4c, arranged with a spacing in a lateral direction of the first elongated member 4. The detent mechanism 34 is positioned between the lateral walls 50, 52. Further, the detent release arrangement 46 comprises two push buttons 54, 56 arranged in openings in the lateral walls 50, 52 and wherein the push buttons 54, 56 are operatively connected to the detent mechanism 34 and movable towards each other for releasing the detent mechanism. Each one of the two push buttons 54, 56 comprises a guide structure 55,57 in the form of two lateral rails for engagement with a complementary shaped guide structure 59, 61 in the form of guide slots in the lateral walls 50, 52 for guiding the push buttons during operation.

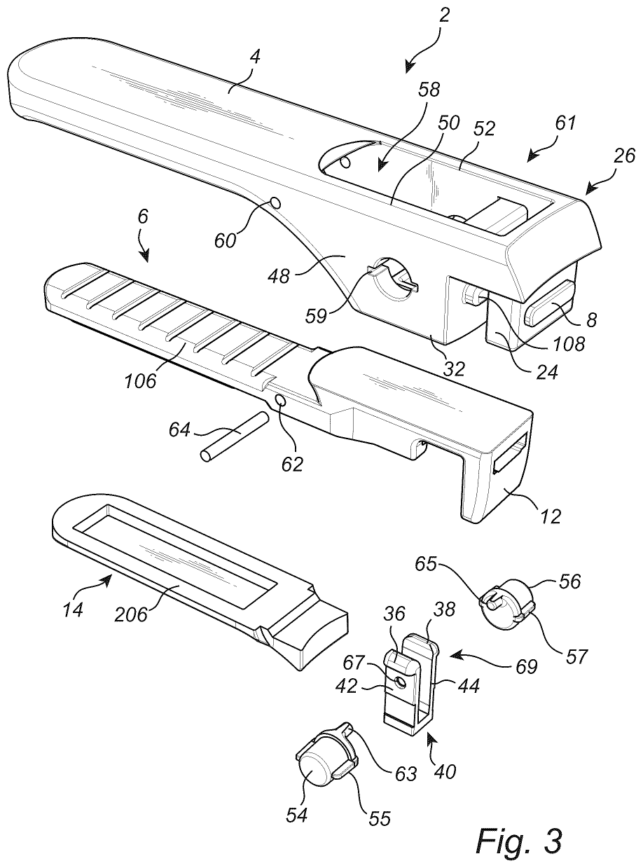

FIG. 3 is an exploded view of parts of the removable handle 2 according to a FIG. 1. The housing 48 of the first elongated member 4 defines an opening 58 for receipt of a portion of the second elongated member 6. More specifically, the opening 58 is defined between the lateral walls 50, 52. Further, each one of the first elongated member 4 and the second elongated member 6 comprises a laterally extending through hole 60, 62, which are adapted to be arranged in line with each other for receipt of a pin 64 for forming the pivot axis 20. The opening 58 is positioned between the through hole 60 for the pivot axis 20 and the front end 26 of the first elongated member 4.

Further, the support portion 24 is formed in one-piece with the housing 48. Likewise, the body portion 32 is formed in one-piece with the housing 48.

The second elongated member 6 comprises one main part 106 and one secondary part 206 provided with the second grip portion 14. The secondary part 206 is rigidly attached to the main part 106.

Turning now to FIG. 4a, FIG. 4b and FIG. 4c indicating the function of the detent mechanism 34 and the detent release arrangement 46. The second elongated member 6 comprises an undercut opening 66 facing downwards for receipt of the two hook parts 36, 38 of the U-shaped element 40 in a locking engagement. It may be noted that the hook parts 36, 38 have an upper beveled surface forming an upwards tapering design and the parts of the second elongated member 6 defining the undercut opening 66 have a similar lower beveled surface forming a downwards tapering design so that the hook parts 36, 38 are pushed towards each other during movement of the removable handle 2 towards the closed state.

FIG. 4b is a cross section view in plane A-A of FIG. 4a, wherein the detent mechanism 34 is indicated in a locked state, wherein the hook parts 36, 38 extends laterally outwards in the undercut opening. FIG. 4c is a cross section view in plane A-A of FIG. 4a, wherein the detent mechanism 34 is indicated in an unlocked state, wherein the push buttons 54, 56 are pushed towards each other and thereby affecting the legs 42, 44 of the U-shaped element 40 and consequently move the hook parts 36, 38 towards each other, wherein the detent mechanism 34 is released and the elongated members 4, 6 may be separated from each other. In other words, the push buttons 54, 56 are spring biased outwardly by means of the flexibility of the legs 42, 44. Each one of the push buttons 54, 56 comprises a pin-shaped projection 63, 65 extending from an inner surface of the push button for affecting the legs 42, 44 of the U-shaped element 40. The pin-shaped projection 63, 65 is adapted to be received in a complementary shaped opening 67, 69 in a respective one of the legs 42, 44. Each one of the pin-shaped projections 63, 65 is provided displaced upwards from a central axis of the respective push button 54, 56.

It may be noted in FIG. 4b that the second elongated member 6 is received in the housing 48 of the first elongated member in the closed state so that an upper surface of the second member 6 is substantially flush with an upper surface of the first elongated member 4.

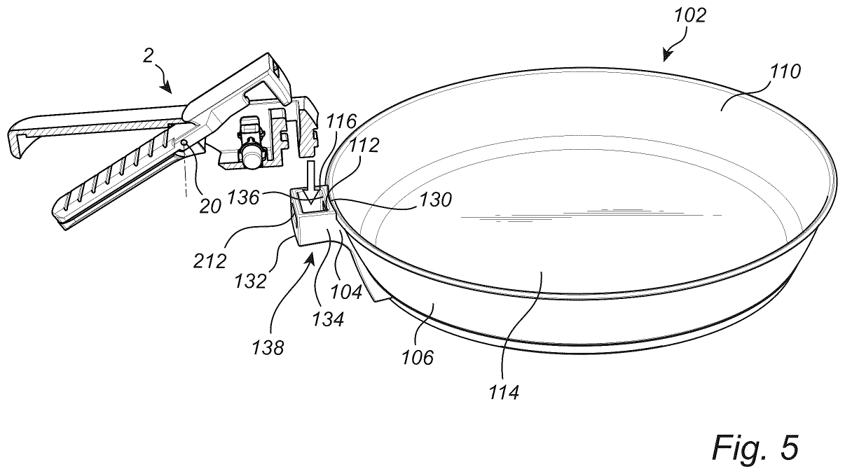

FIG. 5 is a partly cut perspective view of the removable handle 2 and an associated pan 102 according to a first embodiment in an initial assembly state. The pan 102 comprises an attachment member 104 rigidly attached to an outside surface 106 of a container 110 of the pot or pan for allowing attachment of the removable handle 2. The attachment member 104 is rigidly attached to the outside surface 106 of the container 110 via rivets or the like. The attachment member 104 is arranged at a distance from an upper edge or rim of the pot container. More specifically, the attachment member 104 is arranged at such a distance from an edge or rim of the pot container that an upper surface of the handle 2 is substantially flush with the upper edge or rim in an assembled state.

The attachment member comprises a first engagement portion 112, 212 with a main operative extension in parallel with a plane defined by a bottom 114 of the container for engagement with the complementary shaped first engagement portion 8, 108 of the removable handle 2. The first engagement portion 112, 212 is formed by an opening. The attachment member 104 further comprises a second engagement portion 116 in the form of a receptacle that is open in a direction perpendicular to the bottom 114 of the container for receipt of the complementary shaped second engagement portion 12 of the removable handle 2.

More specifically, the attachment member 104 comprises two opposite walls 130, 132 arranged with a spacing for defining the receptacle 116 in a radial direction of the pan 102. Each one of the walls 130, 132 comprises one of said openings 112, 212. Further, the attachment member 104 comprises two opposite lateral walls 134, 136 arranged with a spacing for defining the receptacle 116 in a circumferential direction of the pan 102. Further, the attachment member 104 comprises a bottom wall 138 defining the receptacle 116 in a vertical direction.

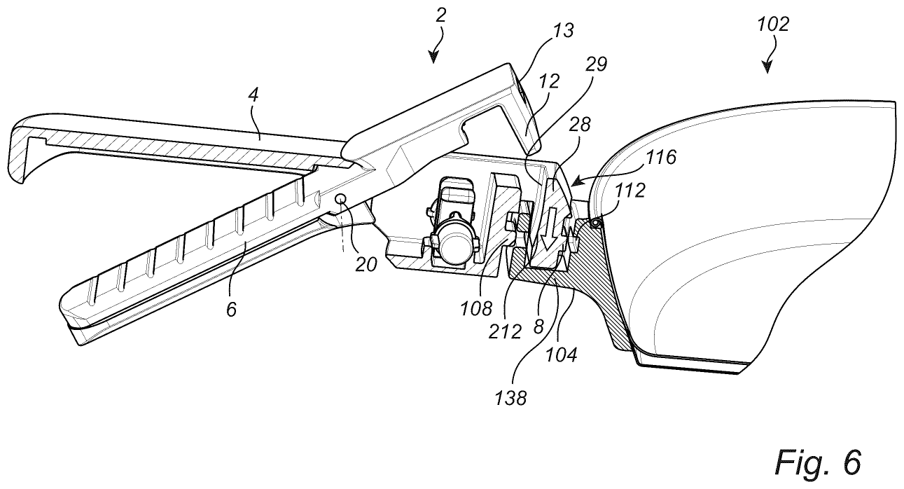

FIG. 6 is a partly cut perspective view of the removable handle 2 and the associated pan 102 according to FIG. 5 in an intermediate assembly state. The removable handle 2 has been moved relative to the pan 110 in an open state so that the support portion 28 at the front end 26 of the first elongated member 4 is received in the receptacle 116 in the attachment member 104. When the removable handle 2 has been moved relative to the pan 110 so that the support portion 28 has reached the bottom wall 138 of the receptacle 116, the projections 8, 108 are vertically at the same level as the openings 112, 212 in the attachment member 104.

The two lateral support surfaces 28, 30 of the support portion 24 are planar and taper towards a free end of the support portion 24 for facilitating entry of the support portion 24 in the receptacle 116 and guiding of the removable handle 2. Corresponding lateral surfaces of the lateral walls 134, 136 defining the receptacle 116 may have a similar tapering shape. In this way, it may be assured that the projections 8, 108 are in line with the openings 112, 212 in the attachment member 104. Thus, the removable handle 2 may be guided to an intermediate assembly position with the elongated members 4, 6 in the open state. An inner surface 29 of the support portion 28 has a slightly curved shape for guidingly receiving a correspondingly shaped curved outer surface 13 of the second engagement member 12.

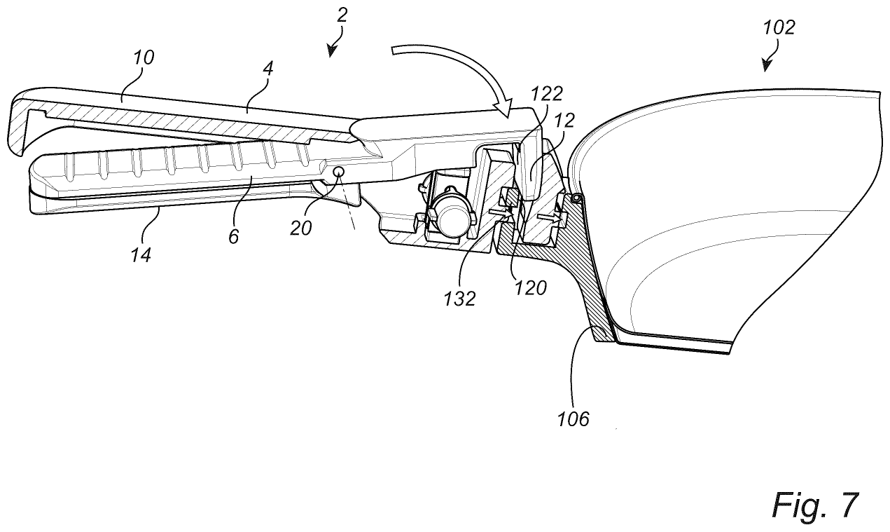

FIG. 7 is a partly cut perspective view of the removable handle 2 and the associated pan 102 according to FIG. 6 in a consecutive assembly state. The second engagement portion 116, and more specifically the wall 132 defining the receptacle radially outwards, comprises a guide surface 120 adapted for a guiding engagement with a guide surface 122 of the second engagement portion 12 of the removable handle 2 so that the removable handle 2 may be moved towards the outside surface 106 of the container of the pan and thereby causing the first engagement portions 8, 108; 112, 212 in engagement with one another when grip portions 10, 14 of the removable handle 2 are moved towards each other.

Thus, the elongated members 4, 6 may be moved from the open state to the closed state so that the removable handle 2 may be moved from the intermediate assembly position to a final assembly position.

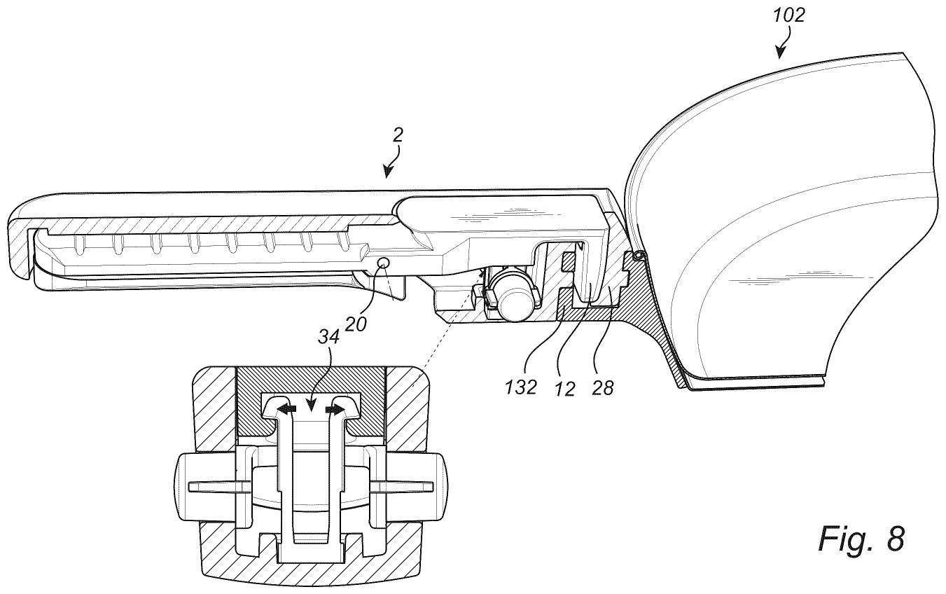

FIG. 8 is a partly cut perspective view of the removable handle 2 and the associated pan 102 according to FIG. 7 in a final assembled state, wherein the detent mechanism 34 is in a locked state. The second engagement portion 12 is arranged in contact with the radial outer wall 132 in one direction and with the support portion 28 in the other direction.

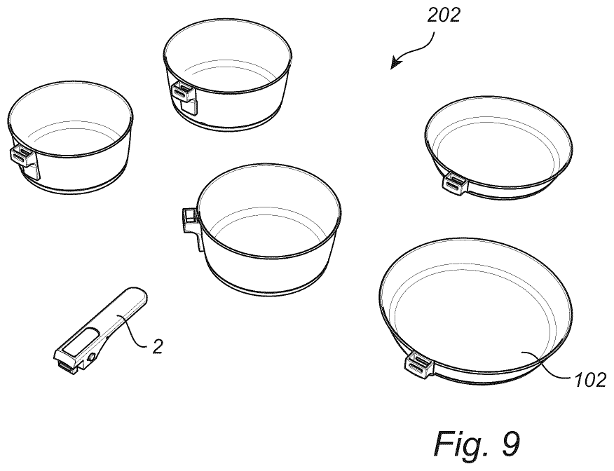

FIG. 9 indicates a kit of parts comprising the removable handle 2 according to FIG. 1 and a plurality of associated pots and pans 102.

It is to be understood that the present invention is not limited to the embodiments described above and illustrated in the drawings; rather, the skilled person will recognize that many changes and modifications may be made within the scope of the appended claims.

According to the first embodiment of the removable handle as described above and shown in the figures, it comprises two first engagement portions, which are arranged in parallel with each other and at a distance from each other in the longitudinal direction of the first elongated member for being received in two associated holes in the attachment member of the pot or pan. It provides for a secure connection between the removable handle and the pot or pan. According to one alternative, the removable handle comprises a single first engagement portion and the attachment member of the pot or pan comprises a single associated hole for receipt of the first engagement portion.

1. A removable handle for pots and pans, comprising:
a first engagement portion and a second engagement portion disposed adjacent a front end of the removable handle and configured for locking engagement with a plurality of complementary shaped engagement portions of an attachment member of a pot and/or a pan;
a first manual grip portion and a second manual grip portion arranged in a rear part of the removable handle, the first grip portion and the second grip portions connected to the first engagement portion and the second engagement portion such that a movement of the first grip portion and the second grip portion towards each other is transmitted to a movement of the first engagement portion and the second engagement portion closer to each other;
a first elongated member including the first engagement portion and the first grip portion; and
a second elongated member including the second engagement portion, the first elongated member and the second elongated member are pivotably connected via a pivot axis;
wherein the first engagement portion has a main operative extension substantially in parallel with a longitudinal direction of the first elongated member;
wherein the second engagement portion has a main operative extension in a transverse direction relative to a longitudinal direction of the second elongated member;
wherein the first elongated member further includes a support portion disposed adjacent the front end for laterally supporting the removable handle relative to a plurality of complementary shaped support surfaces of the attachment member of the pot and/or the pan; and
wherein the support portion has a main operative extension in a transverse direction to the longitudinal direction of the first elongated member.

2. The removable handle according to claim 1, wherein the second engagement portion has a guide surface adapted for a guiding engagement with a guide surface of one of the plurality of complementary shaped engagement portions of the attachment member of the pot and/or the pan such that the removable handle is movable in the longitudinal direction of the first elongated member to cause a movement of the first engagement portion in engagement with another one of the plurality of complementary shaped engagement portions of the engagement member of the pot and/or the pan when the first grip portion and the second grip portion are moved towards each other.

3. The removable handle according to claim 1, wherein the first engagement portion forms a projection for being received in a complementary shaped hole in the attachment member of the pot and/or the pan.

4. The removable handle according to claim 1, wherein the first engagement portion projects from the support portion.

5. The removable handle according to claim 1, wherein the support portion has two spaced apart lateral support surfaces configured for laterally supporting the removable handle relative to the plurality of complementary shaped support surfaces of the attachment member of the pot and/or the pan.

6. The removable handle according to claim 1, wherein:
the first elongated member further includes a body portion;
the support portion is disposed spaced apart from the body portion in the longitudinal direction of the first elongated member; and
the second engagement portion of the second elongated member is configured to be received in a space defined between the body portion and the support portion.

7. The removable handle according to claim 6, wherein the first engagement portion projects from the body portion in the space defined between the body portion and the support portion.

8. The removable handle according to any preceding claim 1, wherein the second elongated member further includes the second grip portion.

9. The removable handle according to claim 1, further comprising a detent mechanism configured to lock the first elongated member and the second elongated member when moved together in a closed state.

10. The removable handle according to claim 9, wherein:
the first elongated member further includes the detent mechanism;
the detent mechanism includes two hook parts that are resiliently separatable from each other when the first elongated member and the second elongated members are moved to the closed state for holding the second elongated member.

11. The removable handle according to claim 10, wherein the detent mechanism further includes a U-shaped element, the U-shaped element including the two hook parts arranged at a plurality of free ends of a plurality of legs of the U-shaped element.

12. The removable handle according to claim 9, further comprising a detent release arrangement, wherein the first elongated member and the second elongated member are pivotably connected at the pivot axis such that the first elongated member and the second elongated member are movable from the closed state to an open state when the detent release arrangement is operated.

13. The removable handle according to claim 12, wherein:
the first elongated member further includes a housing;
the housing includes two lateral walls arranged with a spacing in a lateral direction of the first elongated member;
at least part of the detent mechanism is arranged between the two lateral walls;
the detent release arrangement includes two push buttons arranged in a plurality of openings disposed in the two lateral walls; and
the two push buttons are operatively connected to the detent mechanism and movable towards each other for releasing the detent mechanism.

14. A pot and/or pan, comprising a container and an attachment member rigidly attached to an outside surface of the container for allowing attachment of a removable handle, wherein:
the attachment member includes a first engagement portion with a main operative extension in parallel with a plane defined by a bottom of the container, the first engagement portion configured for engagement with a complementary shaped first engagement portion of the removable handle;
the attachment member further includes a second engagement portion structured as a receptacle opening in a direction perpendicular to the bottom of the container, the receptacle configured for receipt of a complementary shaped second engagement portion of the removable handle; and
the second engagement portion has two lateral support surfaces defining the receptacle and configured for laterally supporting a support portion of the removable handle.

15. The pot and/or pan according to claim 14, wherein the second engagement portion has a guide surface configured for guiding engagement with a guide surface of the second engagement portion of the removable handle such that the removable handle is movable towards the outside surface of the container to cause the first engagement portion and the complementary shaped first engagement portions of the removable handle into engagement with one another when a plurality of grip portions of the removable handle are moved towards each other.

16. The pot or pan according to claim 14, wherein the first engagement portion has a shape of a hole for receiving a complementary shaped projection of the removable handle.

17. A kit of parts, comprising:
a pot and/or a pan according to claim 14; and
a removable handle removably attachable to the pot and/or the pan, the removable handle including:
the first engagement portion and the second engagement portion, which are disposed adjacent to a front end of the removable handle, the first engagement portion of the removable handle configured for locking engagement with the first engagement portion of the pot and/or the pan, the second engagement portion of the removable handle configured for locking engagement with the second engagement portion of the pot and/or the pan;
a first manual grip portion and a second manual grip portion arranged in a rear part of the removable handle, the first grip portion and the second grip portion connected to the first engagement portion and the second engagement portion of the removable handle such that a movement of the first grip portion and the second grip portion towards each other is transmitted to a movement of the first engagement portion and the second engagement portion of the removable handle closer to each other;
a first elongated member including the first engagement portion of the removable handle and the first grip portion; and
a second elongated member including the second engagement portion of the removable handle, the first elongated member and the second elongated member pivotably connected via a pivot axis;
wherein the first engagement portion of the removable handle has a main operative extension substantially in parallel with a longitudinal direction of the first elongated member;
wherein the second engagement portion of the removable handle has a main operative extension in a transverse direction relative to a longitudinal direction of the second elongated member;
wherein the first elongated member further includes the support portion, which is disposed adjacent the front end of the removable handle, for laterally supporting the removable handle relative to the two lateral support surfaces of the second engagement portion of the pot and/or the pan; and
wherein the support portion has a main operative extension in a transverse direction to the longitudinal direction of the first elongated member.

18. A removable handle for pots and pans, comprising:
a first engagement portion and a second engagement portion disposed adjacent a front end of the removable handle and configured for locking engagement with a plurality of complementary shaped engagement portions of an attachment member of a pot and/or a pan;
a first manual grip portion and a second manual grip portion arranged in a rear part of the removable handle, the first grip portion and the second grip portion connected to the first engagement portion and the second engagement portion such that a movement of the first grip portion and the second grip portion towards each other is transmitted to a movement of the first engagement portion and the second engagement portion closer to each other;
a first elongated member including the first engagement portion and the first grip portion;
a second elongated member including the second engagement portion and the second grip portion, the first elongated member and the second elongated member pivotably connected via a pivot axis; and
a detent mechanism configured to lock the first elongated member and the second elongated member in a closed state;
wherein the first engagement portion has a main operative extension substantially in parallel with a longitudinal direction of the first elongated member;
wherein the second engagement portion has a main operative extension in a transverse direction relative to a longitudinal direction of the second elongated member;
wherein the first elongated member further includes a support portion disposed adjacent the front end for laterally supporting the removable handle relative to a plurality of complementary shaped support surfaces of the attachment member of the pot and/or the pan;
wherein the support portion has a main operative extension in a transverse direction to the longitudinal direction of the first elongated member.

19. The removable handle according to claim 18, wherein the second engagement portion of the removable handle has a guide surface adapted for a guiding engagement with a guide surface of the second engagement portion of the pot and/or the pan such that the removable handle is movable in the longitudinal direction of the first elongated member to cause the first engagement portion of the removable handle to engage the first engagement portion of the pot and/or the pan when the first grip portion and the second grip portion are moved towards each other.

20. The removable handle according to claim 18, wherein:
the first elongated member further includes a body portion;
the support portion is disposed spaced apart from the body portion in the longitudinal direction of the first elongated member; and
the second engagement portion of the removable handle is configured to be received in a space defined between the body portion and the support portion.
